(19) United States
(12) Patent Application Publication
(10) Pub. No.: US 2003/0227375 A1
(43) Pub. Date: Dec. 11, 2003

(54) Automotive courtesy display

(76) Inventor: Peter Yong, Torrance, CA (US)

Correspondence Address: Charles H. Thomas, CISLO & THOMAS LLP, Suite 405, 4201 Long Beach Blvd., Long Beach, CA, 90807-2022, US

(21) Appl. No.: 10/165,725

(22) Filed: Jun. 7, 2002

(51) Int. Cl. B60Q 1/00

(52) U.S. Cl. 340/425.5

(57) ABSTRACT

An automotive vehicle courtesy message display system allows the driver of a automotive vehicle to visually display courtesy messages to the drivers of vehicles located to the rear. Such messages may be for an occasional urgent request to “cut in” for safe passage. The message display system provides the driver of the vehicle in which the visual display is installed with an audible feedback so that the vehicle driver can verify that the correct message has been selected, without visually distracting the driver's attention. The system includes three main components, namely a wireless control unit located on the vehicle operator's steering wheel, a processor unit containing most of the electronics of the system positioned in an unobtrusive location so as to avoid impairing the drivers view, and one or a pair of display screens which are typically located behind the rear seat headrests of an automotive passenger vehicle. A microprocessor controller withing the microprocessor unit selects a text message corresponding to the particular touch sensor depressed, and transmits it to an appropriate one the display screens. The audible announcement of the message selected by the touch sensor provides the operator with a positive feedback indicating selection of the correct message.

### BACKGROUND OF THE INVENTION

1. Field of the Invention

The present invention is a system for electronically displaying courtesy messages by a driver within one automotive vehicle to drivers of other nearby automotive vehicles.

2. Description of the Prior Art

Various automotive courtesy message display systems have been devised for allowing the operator of an automotive vehicle to display courtesy or informational messages to the operators of other nearby automotive vehicles. Such messages are useful for requesting an act of courtesy on the part of the operator of a nearby vehicle and for expressing graciousness toward the actions that have been taken by another automotive vehicle operator.

Conventional devices of this type are often located on the outside of a vehicle, either upon the trunk or rear body structure of the vehicle. Alternatively, they may be located within the vehicle, but visible through a rear windshield. Conventional devices of this type are described, for example, in U.S. Pat. Nos. 5,905,434 and 6,300,870.

One significant shortcoming of conventional automotive vehicle courtesy message display systems is that they simply cannot be read by the drivers of other vehicles for whom they are intended due to interference from ambient light. Conventional courtesy message display systems of this type are typically displayed utilizing an LCD display panel. While displays of this type are readily visible to other nearby drivers in view of the display during hours of darkness, ambient daylight interferes with such displays to such an extent that the intended recipient of the message simply cannot visually make it out. Accordingly, conventional displays of this type have limited utility, since they are really only useful during the hours of darkness. The vase majority of driving time of automotive vehicles typically occurs during daylight hours. It is during the daylight that conventional illuminated message display systems are ineffective.

Another difficulty with conventional message display systems is that the display is quite bulky. If it is installed for observation through the rear windshield of a vehicle, it often significantly obstructs the rear view of the driver of the vehicle in which it is installed. Thus, display of a courtesy message, though meant as a gesture that will facilitate the flow of traffic and thereby reduce accidents, actually becomes a hazard due to its vision limiting position in the vehicle.

A further disadvantage of conventional automotive courtesy message display systems is the lack of a suitable mounting system. For example, U.S. Pat. No. 6,304,174 discloses an emergency auto visual communication system utilizing a display that is attached to the rear windshield of a vehicle utilizing suction cups. The positioning of the display in this manner not only presents a significant visual obstruction to the driver of the vehicle in which it is installed attempting to see through the rear windshield, but also is largely ineffective. Available suction cup systems simply will not hold the display in position for any significant length of time.

A further disadvantage of conventional automotive vehicle courtesy message display systems is the distracting effect they have upon the driver operating them. That is, to operate such a system the driver must carefully look at a message selection system with sufficient scrutiny to be assured of having selected the intended message. This requires the distraction of the visual attention of the driver from the traffic and the road ahead. Conventional automotive courtesy message display systems offer no selection verification system that does not demand the visual attention of the driver.

### SUMMARY OF THE INVENTION

One object of the present invention is to provide an automotive vehicle message display system which displays messages of courtesy, warnings, greeting, or other information in such a manner that it is not obscured by the presence of ambient light. In this connection the automotive message display system of the present invention is mounted within a vehicle and is visible through the rear window of the vehicle, but is provided with a hood projecting out over the upper portion of the display so as to shade the display from ambient light. As a consequence, the illuminated characters in the message display have far greater visibility to nearby drivers than conventional message display systems.

Another object of the invention is to reduce road rage among drivers and thereby lower insurance premiums. The system is also very useful for educational purposes, especially to children and young drivers.

A further object of the present invention is to provide an automotive vehicle courtesy message display system that minimizes the visual obstruction through the rear windshield to the driver of the vehicle in which the message display system is installed. This objective may be achieved in a conventional passenger automobile by providing dual display units, one located behind each of the rear seat headrests of the vehicle. Virtually all conventional passenger vehicles are provided with front seats for the operator and at least one passenger, and a rear seat for additional passengers. The rear seat is typically configured to provide seating areas to the left and right of the center of the vehicle and to provide rear seat headrests at these locations. The headrests are actually provided for safety reasons to minimize whiplash that might occur in a collision.

According to the present invention, the dual display units of the automotive vehicle courtesy message display system of the invention are positioned directly behind each of the two rear seat headrests. Thus, the display units are located at positions facing the rear vehicle windshield in such a manner that they do not obstruct the vision of the driver looking through a rearview mirror, back through the center of the vehicle and out of the rear windshield.

The visual obstruction presented by the display unit or units of the courtesy message display system of the invention is also significantly reduced by positioning only the display screen itself at a location above the level of the rear deck panel behind the rear vehicle seat. In conventional electronic courtesy message display systems the power unit for the display is located within the same housing as the actual LED elements that display the message. According to the present invention, however, the electronic drivers for the message display screen or screens are located within a separate casing that may be positioned at a location beneath the rear deck panel of the vehicle so as not to prevent a visual obstruction to the view of the driver through the rear window.

All of the operating electronics for the courtesy message display system of the invention are located within a housing that may be positioned out of the way and out of view of any occupant of the vehicle. More specifically, the housing containing most of the electronics for the message display system of the invention is preferably located directly beneath the generally horizontal deck that typically extends from the back of the rear seat headrests to the base of the rear windshield of most passenger vehicles. This area is typically accessible from the trunk of the vehicle. Thus, the largest bulk of the display unit of the invention is located in a concealed storage location so that it does not present a hazzard to persons in the vehicle in case of a collision. Also, the concealment of the major portion of the equipment prevents interference with the rear view vision of the driver of the vehicle.

A further feature of the invention is the very versatile mounting system which allows the display units to be installed in automotive vehicles having a variety of sizes and configurations. In this connection, the display screen units are mounted upon display supports that may moved along a mounting rail and secured thereto at appropriate positions on the mounting rail. Also, the mounting rail itself is constructed using members that are telescopically connected together so that the length of the mounting rail can be adjusted to the width of the vehicle at a location directly behind the rear passenger seat. Also, the outboard ends of the telescoping rail are provided with feet that are pivotally mounted to the ends of the rails so as to accommodate different surface configurations found at the interior walls near the rear of the passenger compartment of different vehicles.

In one broad aspect the invention may be considered to be an electronic courtesy display system for mounting within the enclosure of an automotive vehicle comprising: a display unit, an operator console, an electronic storage memory, a display driver unit, and a speaker. The display unit has an elongated display screen for positioning for viewing through the rear window of an automotive vehicle from outside the vehicle. The display unit is also provided with a hood positioned to shade the display screen. The operator console provided is suitable for mounting upon the steering wheel of an automotive vehicle. The operator console includes a plurality of touch sensitive sensors, a unique operator message indicia for each of the sensors, and a transmitter for generating a unique, identifying signal for each of the sensors. Preferably, the transmitter is a radio-frequency transmitter. The electronic storage memory contains a plurality of preprogrammed alphanumeric messages in electronically encoded form. The electronic storage memory is responsive to each sensor identifying signal to select a corresponding one of the preprogrammed messages. The display driver unit is coupled to receive messages from the electronic storage memory as they are selected and to actuate a corresponding character display by the display screen. The speaker audibly announces each message contemporaneously with its selection by the touch-sensitive sensor. The driver of the vehicle thereby receives an audible feedback verifying the selection of the desired message. By providing an audible feedback it is unnecessary for a driver's visual attention to be distracted from the road and traffic ahead in order to verify selection of the appropriate message.

In another aspect the invention may be considered to be an electronic automotive message display system comprising an elongated display unit, an audio speaker, a message selection device, a receiver for responding to remotely generated signals to display a set of selected alphanumeric characters in a selected sequence, a touch-sensitive operator panel containing touch-sensitive selectors for alternatively selecting one of a plurality of encoded messages for display, and a display driver unit separate from the elongated display unit.

The elongated display unit is designed for positioning in the rear windshield of an automotive vehicle and has a display screen for displaying a linear array of alphanumeric characters. The elongated display unit is also provided with a sunshield that casts a shadow on the display screen. In addition, the elongated display unit is provided with the audio speaker.

The message selection device includes a memory containing a plurality of preselected, electronically encoded messages. Each message is formed of a different set of selected alphanumeric characters in a selected sequence. The message selection device is coupled to the receiver. The touch-sensitive operator panel is adapted for positioning on the steering wheel of an automotive vehicle. A transmitter is provided in the operator panel for generating a signal recognizable by the receiver as specifying the selected one of the messages. The display driver unit responds to the receiver by actuating the display screen to display the selected message on the display screen. The display driver also actuates the audio speaker to audibly announce the selected message.

The invention may be described with greater clarity and particularity by reference to the accompanying drawings.

### DESCRIPTION OF THE DRAWINGS

FIG. 1 a block diagram illustrating the functional electronic components of a electronic automotive courtesy message display system according to the invention.

FIG. 2 is a rear elevational view from the exterior of an automotive vehicle in which the electronic automotive message display system has been installed, illustrating display of one of a plurality of stored messages.

FIG. 3 is a rear elevational view of the automobile of FIG. 2 illustrating display of an alternative one of the stored messages.

FIG. 4 is a side sectional detail taken along the lines 4-4 of FIG. 2.

FIG. 5 is a perspective view illustrating the message display units shown in FIGS. 2 and 3 and the system for mounting those units within an automotive vehicle.

FIG. 6 is an elevational view of the touch-sensitive operator panel in the message system of the invention mounted on the vehicle steering wheel.

FIG. 7 is a diagram indicating in greater detail examples of the messages that can be selected for display.

FIG. 8 is a diagram illustrating the interrelationship of the message display unit and the display driver unit for a dual display message display system.

FIG. 9 is a diagram illustrating the interrelationship between the display driver unit and a single display unit in a message display system according to the invention.

### DESCRIPTION OF THE EMBODIMENT

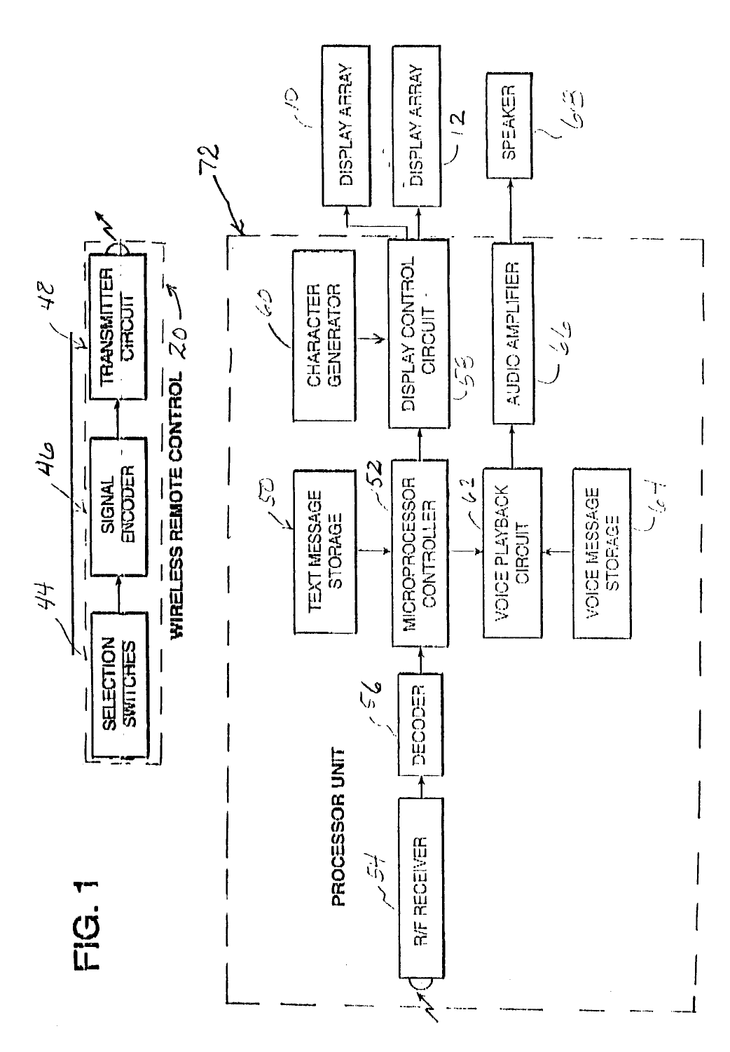

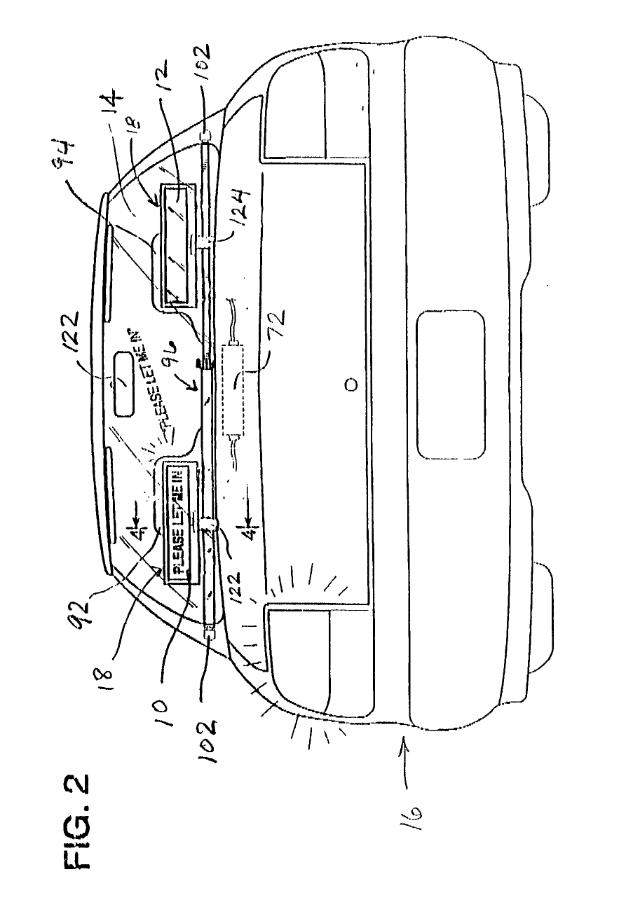

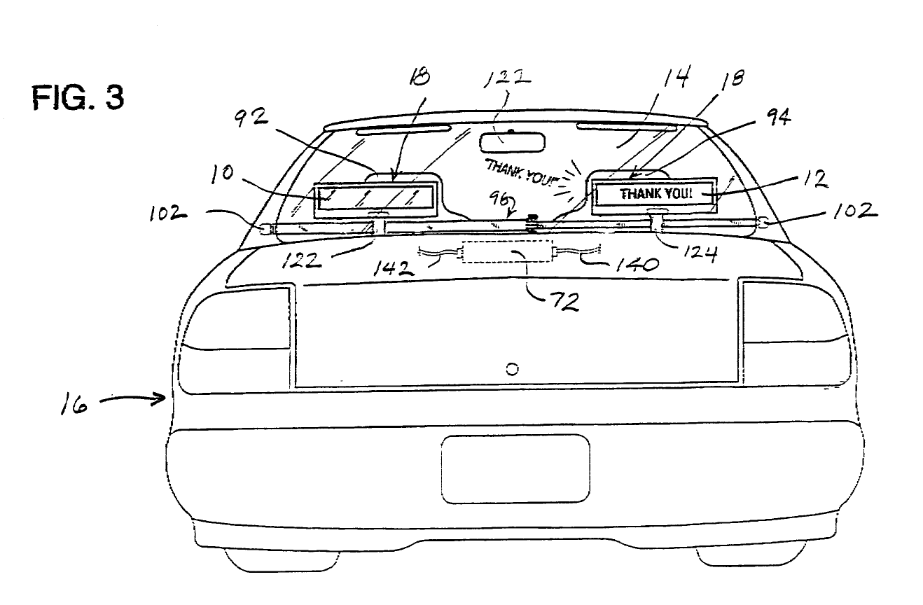

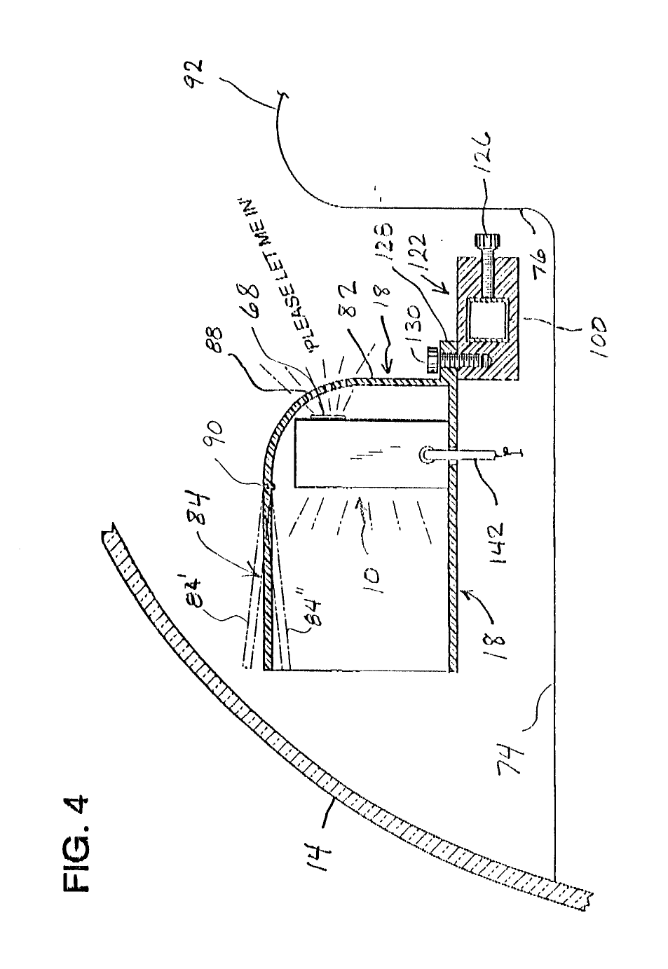

FIG. 1 illustrates diagrammatically the electronic components of an electronically operated visual courtesy message display system for an automotive vehicle constructed according to the present invention. Specifically, the display system of the invention includes at least one, and preferably dual, thin, elongated message display screens 10 and 12 that are positionable for viewing through the rear window 14 of an automotive vehicle 16 from the exterior thereof, as illustrated in FIGS. 2 and 3. As illustrated in FIG. 4, a display screen hood 18 is provided for shading each of the display screens 10 and 12.

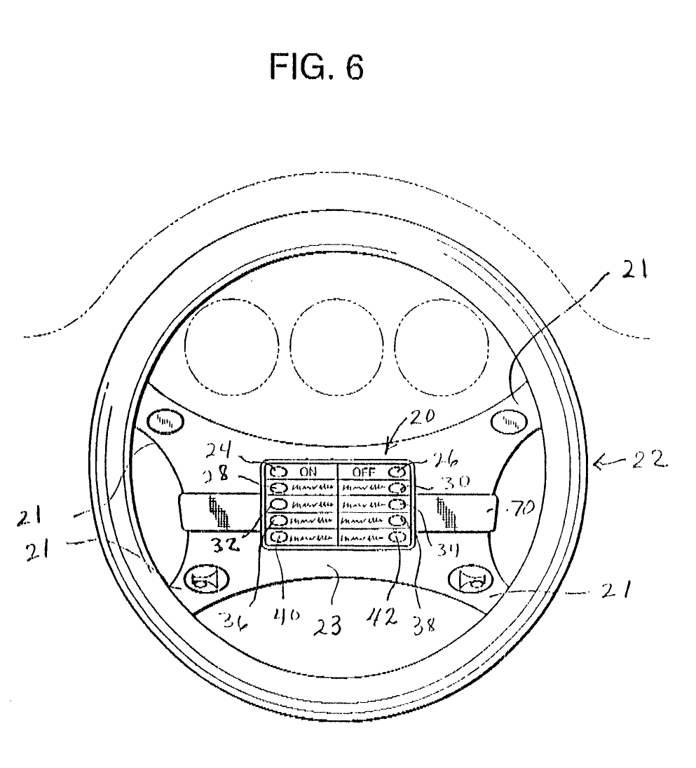

FIG. 6 illustrates an operator panel or console 20 for mounting on the center 23 of a steering wheel 22 of the automotive vehicle 16. The operator console 20 includes an array of a plurality of individually actuable touch-sensitive selectors 24 through 42. Each of the selectors 24 through 42, upon actuation, provides a unique identifying electronic signal. The entire array of the electronic selectors 24 through 42 is indicated at 44 in FIG. 1. The console 20 also includes a signal encoder 46, responsive to the selection of a particular one of the touch-sensitive switches 24 through 42 in the array of switches 44 to provide a unique identifying electronic signal to a radio-frequency transmitter 48 that generates an RF version of the unique identifying electronic signal produced by the signal encoder 46. The wireless console 20 utilizes a single chip device which scans for momentary depression of the touch-sensitive switches 28-42. When a switch closure is detected, the transmitter 48 transmits a radio frequency signal that identifies the switch selected.

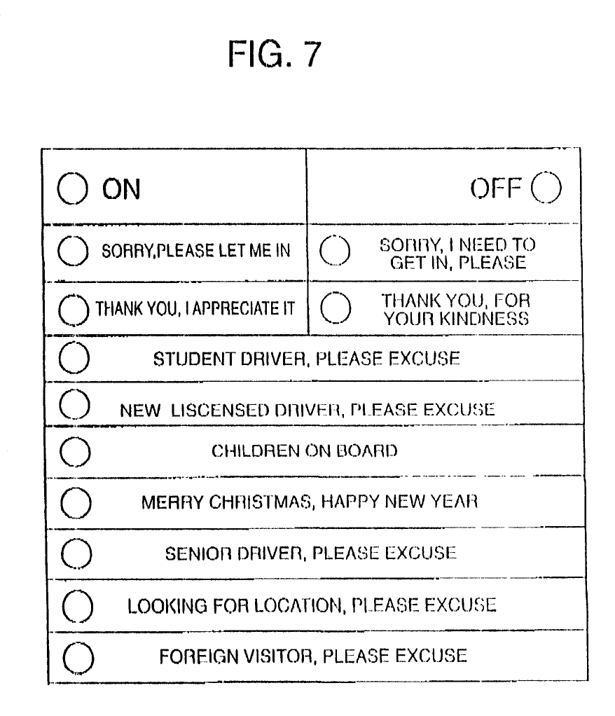

As indicated in FIG. 6, the operator console 20 includes labeled indicia at each of the touch-sensitive selection switches 24 through 42 for visually identifying to an operator a unique alphanumeric message associated with each of the selectors 28 through 42. These messages are indicated more clearly in FIG. 7.

The visual display system of the invention further includes an electronic storage memory 50 that contains a plurality of displayable visual alphanumeric messages stored in an electronically encoded form. More specifically, the messages indicated in FIG. 7 are electronically stored in the text message storage unit 50 indicated in FIG. 1. A microprocessor controller 52 is responsive to each of the unique identifying electronic signals generated by the transmitter circuit 48 and received by the RF receiver unit 54 and decoded by the decoder unit 56. The microprocessor controller 52 recognizes from the decoder 56 the signal indicating which of the particular selection switches 24 through 42 in the selection switch array 44 has been actuated. The microprocessor controller 52 recalls from the text message storage memory 50 a corresponding one of the alphanumeric messages indicated in FIG. 7 and transmits that message in electronically encoded form through a display control driver circuit 58. The display control driver circuit 58 receives character generator information from a character generator unit 60 and provides driving display signals to the appropriate display screen 10 or 12, as designated by the column in the selector array 44 in which the actuated one of the selectors 24-28 lies.

Concurrently, the microprocessor 52 also provides an output indicative of the selected message to a voice playback driver circuit 62. The voice playback driver circuit 62 selects an audio encoded version of the same message being transmitted to the display screen 10 or 12 from a voice message storage unit 64 and transmits the audio version of that message to an audio amplifier 66. The audio amplifier 66 in turn provides an output of the audio encoded version of the message to a speaker 68, which is located within at least one of the display screens 10 or 12. For reasons of economy, a single speaker 68 may be located in the rear of the display screen 10 and provide audible announcement of the particular message selected, whether it has been selected for display in the display screen 10 or in the display screen 12. The mini audio amplifier speaker 68 is integrated into the display screen enclosure on the side opposite the rearwardly facing display screen panel 10, as indicated in FIG. 4.

An audible version of the selected message is announced to the driver of the vehicle 16 so that the driver can verify that the proper touch-sensitive switch in the switch array 44 was activated. The position of the touch-sensitive switches in an array located at the center of the vehicle steering wheel allows the vehicle driver to momentarily actuate any particular sensor 24-42 with either the right or left thumb of the driver's hands. The vehicle driver can thereby operate the control panel 20 without loss of concentration on the road and traffic ahead.

The operator console 20 containing the message selection sensor array 44 is fabricated as a thin, small, rectangular panel or pad that fits within the central area 23 of the steering wheel 22 and is secured thereto by a releaseable elastic band 70 that passes through openings between the spokes 21 of the steering wheel 22. The elastic band 70 secures the operator console 20 so that it is supported from behind by the central portion 23 of the steering wheel 22. Plastic clips or other fastening means such as flexible hook and loop fabric fastener pads of the type sold under the registered trademark Velcro® may be utilized in place of the elastic band 70 to secure the operator console 20 onto the center 23 of the steering wheel 22.

The touch-sensitive sensors 24 and 26 are provided to turn the operator console 20 on or off, respectively. When the “on” sensor 24 is depressed an electrical contact is made beneath the surface of the display 20 and a signal is generated by the signal encoder 46 and transmitted by the transmitter circuit 48 to the radio-frequency receiver 54, which is housed within a protective case 72. This introductory signal is processed through the microprocessor controller 52 to direct the voice playback circuit 62 to select a greeting message from the voice message storage unit 64. This greeting message may, for example, be an audio greeting such as “Welcome to your automotive courtesy display system”. The electronically coded audio message is retrieved from the voice message storage unit 64 and connected by the voice playback circuit 62 to the audio amplifier 66, which is connected to the speaker 68 indicated in FIGS. 1 and 4.

Similarly, depression of the “off” touch sensor 26 may initiate a comparable audio message from the speaker 68, such as “Automatic courtesy message display system shutting down”. Alternatively, depression of the sensor 26 may simply turn off power to the unit.

Once the selector switch 24 has been depressed, power to the courtesy message display system of the invention is on. Courtesy message selections may then be made utilizing the touch-sensitive message selection switches 28-42.

The touch-sensitive sensors 28 and 30 are respectively associated with the vehicle driver side display screen 10 and the vehicle passenger side display screen 12. Depression of either the touch-sensitive sensor 28 or 30 initiates essentially the same courtesy message, although phrased slightly differently. Depression of the touch-sensitive sensor 28 initiates the display in the driver's side display screen 10 of the message “Sorry, please let me in”. Similarly, depression of the touch-sensitive sensor 30 initiates a display on the passenger's side display screen 12 of the message, “Sorry, I need to get in, please”. This message will appear on the passenger side display screen 12. Both messages are visible through the automotive vehicle rear window 14.

Both of the messages initiated by depression of the touch-sensitive sensors 28 and 30 are displayed as a result of essentially the same electronic signal processing. That is, the signal encoder 46 generates a signal indicative of the particular one of the plurality of touch sensors 24 through 42 that has been depressed and operates the transmitter circuit 48 to transmit a radio frequency version of this key or touch-sensor identification signal.

The system employs a control unit casing 72 containing the electronically stored messages and the display driver unit. This casing 72 is located apart from the display screens 10 and 12, the operator console 20, and the speaker 68. The casing 72 is positioned for concealment from view within the automotive vehicle.

All of the signal storage components of the processor unit are located within the small, flat, rectilinear case 72, which is preferably located beneath the generally horizontal, rear deck 74 of the automotive vehicle 16. The rear deck 74 is located behind the rear seat back 76, indicated in FIG. 4. More specifically, the rear deck 74 extends from the back side of the rear passenger seat back 76, just beneath the rear seat headrests 92 and 94, horizontally and rearwardly to the base of the rear windshield 14. The casing 72 that contains most of the electronic components of the courtesy message display system of the invention is located directly beneath the rear deck 74.

At the time of purchase the touch-sensitive selector array 44 is preprogrammed with totally predetermined responses to depression of the sensors 28, 30, 32, and 34. The responses associated with touch sensors 36, 38, 40, and 42 are also preprogrammed, but are selected and designated at the time the sensor array 44 is set up from among a larger number of messages.

FIG. 7 illustrates diagrammatically the messages stored in the text message storage unit 50. As previously indicated, the responses associated with depression of the “on” sensor 24 and the “off” sensor 26 are predetermined and cannot be changed. Likewise, the messages designated for the touch sensors 28, 30, 32, and 34 are also invariable and cannot be changed. These messages are: sensor 28—“Sorry, please let me in”; sensor 30—“Sorry, I need to get in, please”; sensor 32—“Thank you, I appreciate it”; and sensor 34—“Thank you for you kindness”.

On the other hand, the messages associated with depression of the touch sensors 36, 38, 40, and 42 may be selected from among the remainder of the messages indicated in FIG. 7. All of these messages are stored as text messages in the text message storage unit 50. Once the selection of the elective messages of FIG. 7 to be displayed has been performed by the owner of the courtesy message display system, each depression of the touch sensor 36 will cause the microprocessor 52 to elicit the same, designated one of the messages indicated in FIG. 7. That message is withdrawn from the text message storage unit 50 each time the touch sensor 36 is depressed. The same is true of depression of the touch sensors 38, 40, and 42.

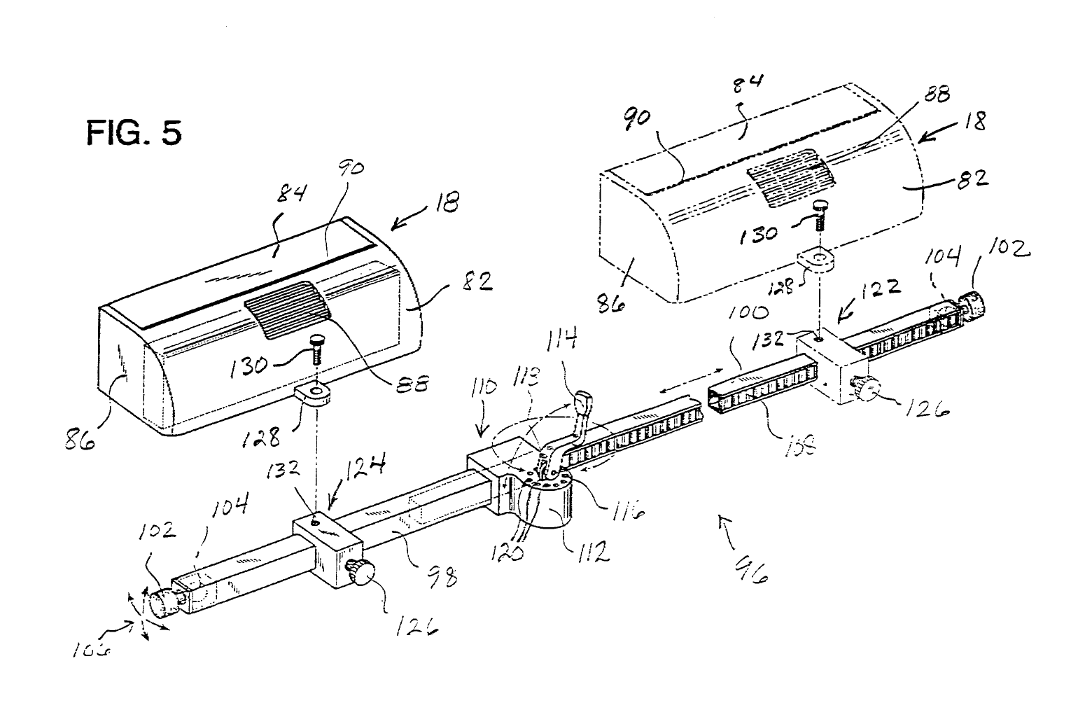

FIGS. 4 and 5 of the drawings illustrate an important aspect of the invention, namely the provision of the hood 18 for each of the display screens 10 and 12. Identical hoods 18 are utilized for each of the display screens 10 and 12.

Each of the display screens 10 and 12 is preferably about two inches in height, about ten to twelve inches in length, and less than an inch in thickness. The rearwardly facing surfaces of the display screens 10 and 12 are preferably each covered with an antiglare glass or plastic surface, which further reduces visual impairment due to ambient light.

As illustrated in FIGS. 4 and 5, each of the hoods 18 is constructed as a plastic structure having an upright forward wall 82 that is rounded rearwardly at its upper extremity to form a roof and which includes a generally rectangular, rearwardly projecting overhead shading visor 84. Each hood 18 includes opposing end panels 86 that restrict the amount of light that is cast upon the display screens 10 and 12 from the sides. A slotted, generally rectangular plastic speaker grill 88 is formed in the hood 18 at the rounded transition between the forward wall 82 and the roof of the hood 18.

The overhead visors 84 of the two hoods 18 extend rearwardly from the display screens 10 and 12 and between the side blinders formed by the end panels 86 of the hoods 18. Each overhead visor 84 includes a laterally extending living hinge 90 so that the orientation of at least a portion of the roof of the hood 18, namely the visor panel 84, is adjustable relative to the display screen with which it is associated. The rearwardly projecting overhead visor panel 84 is located atop and extends between the side blind panels formed by the ends 86 of the hood 18. The laterally extending living hinge 90 is thereby also adjustable in orientation relative to the side blind panels formed by the ends 86 of the hood 18.

The end panels 86 serve as side blinders at the opposing ends of the display screens 10 and 12 and the overhead visor 84 is generally horizontally disposed and projects rearwardly above the display screen 10 or 12 and toward the rear window 14 of the automotive vehicle 16. As illustrated in FIG. 4, the overhead visor 84 is connected to the remaining structure of the hood 18 by the transverse, flexible living hinge joint 90 that allows the visor 84 to be adjusted in orientation relative to the display screen 10 or 12 located beneath it and forwardly therefrom. As indicated in FIG. 4, the overhead visor 84 may be lifted upwardly to the position indicated at 84′ in FIG. 4, where it is oriented with a slight upward and rearward orientation. Alternatively, the overhead visor 84 may be moved about the stiff, living hinge connection 90 downwardly at an incline to the position indicated at 84″ in FIG. 4. The precise orientation of the overhead visor 84 can preferably be varied between about ten and fifteen degrees by moving it upwardly or downwardly relative to horizontal about the stiff hinge 90, as illustrated in FIG. 4.

As indicated in FIG. 5, the embodiment of the electronic courtesy message display system of the invention illustrated in the drawings employs a pair of elongated, thin display screens 10 and 12, one for positioning behind each rear seat headrest 92 and 94 of the automotive vehicle 16. As indicated in FIG. 6, in addition to the “on” touch sensor 24 and the “off” touch sensor 26, the remaining touch sensors 28-42 are located in an array of two columns, one associated with each of the display screens 10 and 12. The left-hand column of touch sensors 28, 32, 36, and 40 produces messages in the driver's side display screen 10. The right-hand column of touch sensors 30, 34, 38, and 42 in the operator control panel 20 shown in FIG. 6 elicit the display of messages on the passenger-side display screen 12.

The display screen mounting system of the invention is very versatile and may be utilized in most commercially available automotive vehicles designed primarily for transporting passengers. The laterally extendable display screen mount 96 is illustrated in detail in FIG. 5. The display screen mount 96 includes a pair of telescoping tubes 98 and 100, each having an outboard end and an inboard end. Padded feet 102 are located at the outboard ends of the tubes 98 and 100. As illustrated, the feet 102 are secured to the outboard ends of the telescoping tubes 98 and 100 by omnidirectional connectors, which are ball and socket connectors 104. The provision of omnidirectional connectors for the padded feet 102 allows the angulation of the padded feet 102 to be adjusted relative to coaxial alignment with the telescoping tubes 98 and 100 as illustrated by the directional arrows indicated generally at 106 in FIG. 5. Thus, the feet 102 can be oriented to bear against the inside surfaces of the interior passenger compartment walls of the automotive vehicle 16. These walls exhibit a wide variety of curvatures above the deck 74 just forward of the rear windshield 14 in different models of vehicles.

The relative extension of the telescoping tubes 98 and 100 is also adjustable. As illustrated in FIG. 5, each of the telescoping tubes 98 and 100 is constructed with a square outer cross-sectional configuration. The telescoping tube 98 is hollow so as to receive, at its inboard extremity, the inboard extremity of the other telescoping tube 100 therewithin. One side of the telescoping tube 100 is configured in the shape of a rack 108 which has a multiplicity of teeth arranged along the length of the tube 100. The inboard extremity of the other telescoping tube 98 is equipped with a pinion and crank mechanism 110 for selectively adjusting and maintaining the desired degree of telescopic offset between the tubes 98 and 100. The pinion crank mechanism 110 includes a pinion mounted for rotation about a vertical axis within a housing 112. A crank lever 114 is attached to the upper end of the pinion axle by means of a hinge connection 116. Near the hinged end of the crank lever 114 there is a locking pin 118 that fits into corresponding locking openings 120 arranged in a circular pattern on the top of the pinion housing 112.

The crank lever 114 may be rotated about the vertical pinion axle in either a clockwise or counterclockwise direction relative to the pinion housing 112 to rotate the pinion therewithin. The pinion engages the rack 108 to either extend the outboard ends of the telescoping tubes 98 and 100 further apart from each other, or retract them toward each other, depending upon the width of the passenger compartment of the vehicle 16.

The rack and pinion arrangement formed by the rack 108 and the pinion crank mechanism 110 serves as an extension mechanism for forcing and holding the padded feet 102 at the outboard ends of the tubes 98 and 100 apart from each other and against the interior walls of the automotive vehicle 16. The telescoping tubes 98 and 100 extend across the width of the vehicle 16 proximate the rear window 14 thereof. The pin 118 of the crank lever 114 serves as a latch device for holding the pinion within the housing 112 at a selected location relative to the rack 108.

To install the mounting display screen mounting system 96 the crank lever 114 is first operated to retract the telescoping tube 100 into the other hollow telescoping tube 98 to a sufficient extent that the display screen mount 96 may be inserted into the passenger compartment of the vehicle and positioned behind the rear seat headrests 92 and 94. The display screen mounting system 96 is installed just above the deck 74 with the padded feet 102 directed outwardly toward the opposing interior sides of the vehicle passenger compartment. The crank lever 114 is then operated to rotate the pinion so that the pinion teeth interact with the teeth of the rack 108 and extend the telescoping tube 100 further out of the other telescoping tube 98. This causes the padded feet 102 to be pushed outwardly and to bear against the interior surfaces of the vehicle passenger compartment just above the deck 74, as illustrated in FIGS. 2 and 3. As previously indicated, the swiveling nature of the ball and socket connections 104 allows the alignment of the padded feet 102 to be adjusted somewhat so as to properly bear outwardly to exert maximum outward pressure against the interior sides of the passenger compartment of the vehicle 16 above the deck 74.

With the padded feet 102 frictionally engaged with the interior passenger compartment walls so that the display screen mount 96 is firmly held in position behind the rear seat headrests 92 and 94, the crank lever 114 is rotated downwardly toward the pinion housing 112 to engage the locking pin 118 in the closest locking pin aperture 120 with which it is aligned. The interengagement of the locking pin 118 in the selected aperture 120 forms a locking latch that immobilizes the telescoping tubes 98 and 100 relative to each other. Interengagement of the locking pin 118 of the crank lever 114 with the aligned locking aperture 120 selectively adjusts and maintains a desired degree of telescopic offset between the tubes 98 and 100.

Each of the display screens 10 and 12 may then be laterally adjusted to a proper position directly behind the rear seat headrests 92 and 94 so as to minimize any visual obstruction of view by the vehicle driver using the rearview mirror 122 to look out through the rear windshield 14. To perform this adjustment the display screen mount 96 is provided with a pair of mounting brackets 122 and 124 that are each slidably mounted relative to the telescoping tubes 100 and 98, respectively, for positioning across the width of the passenger compartment. Specifically, the mounting bracket 122 is slidably mounted on the telescoping tube 100, while the mounting bracket 124 is slidable mounted on the telescoping tube 98.

The telescoping tubes 98 and 100 are each of a uniform cross section throughout. Each of the mounting brackets 122 and 124 is therefore formed with a square opening of appropriate dimensions for mounting in sliding engagement with the outer surface of the telescoping tube for which it is designed. That is, the mounting bracket 122 includes a square opening through its structure only slightly larger than the outer cross-sectional size of the telescoping tube 100, while the mounting bracket 124 has a slightly larger square opening through its structure to accommodate the slightly larger telescoping tube 98.

As illustrated in FIGS. 4 and 5, both of the mounting brackets 122 and 124 include a releaseable clamp in the form of a set screw 126 that is directed inwardly and engaged in an internally tapped opening in its mounting bracket so as to be advanced and retracted relative to the telescoping tube encompassed within the mounting bracket. The set screw 126 of the mounting bracket 122 can thereby be advanced to clamp against the telescoping tube 100, while the set screw 126 of the mounting bracket 124 can be advanced to clamp against the facing side walls of the telescoping tube 98. The set screws 126 serve as releaseable clamps for locking the mounting brackets 122 and 124 at selected locations along the telescoping tubes 100 and 98, respectively.

The display screens 10 and 12 are each housed within a separate hood 18. The hoods 18 have forwardly projecting mounting tabs 128 with vertical openings defined therethrough. Clamping screws 130 are provided and are directed through the openings in the hood-mounting tabs 128 and are engageable in internally tapped vertical bores 132 defined in each of the mounting brackets 122 and 124. The hoods 18 are thereby securely but releaseably attached to the mounting brackets 122 and 124. Each hood 18, and consequently the display screen 10 or 12 located therewithin, may be varied in orientation relative to the rear windshield 14 by twisting the mounting tab 28 slightly relative to the axis of the fastener 130 so as to hold the display screens 10 and 12 directed for maximum visibility through the rear windshield 14.

It is important to minimize the bulk of the components that are employed both in the operator console 20 and in the display screens 10 and 12. Unlike conventional display systems, the display screens 10 and 12 contain only the minimum components necessary to actually display the messages that are stored and processed in the processor unit. This allows each of the display screens 10 and 12 to be very thin, no more than a fraction of an inch in thickness. Consequently, the display screens 10 and 12 can be positioned well forward in their hoods 18 so that the overhead visors 84 and the side blinder end panels 86 project rearwardly beyond the rear display face of each display screens 10 and 12 a distance of between three and one-half and four and one-half inches from the display surface.

The hoods 18 are normally fabricated of a neutral-colored plastic material, which may be a dull black or gray. Because most of the electronics have been repositioned from the display screens 10 and 12 to the electronic processor unit 72, and because the hoods 18 and the display mount 96 are formed of light-weight materials, none of the display apparatus that is located in the passenger compartment of the vehicle is very heavy at all. This light-weight construction of all of the components that reside behind the rear seat headrests 92 and 94 minimizes the chance of any injury to the passengers in the event of a collision. That is, all of the display apparatus illustrated in FIGS. 4 and 5 is so light in weight it would not cause injury to passengers within the vehicle 16, even if thrown forward due to the force of impact of a collision with the vehicle 16.

Once the display mount 96 has been installed in the manner described, it may be advisable for the display mount 96 to be covered for cosmetic reasons. This covering could take the form of a simple, elongated cloth covering colored to match the interior color of the vehicle. The cloth covering can be placed lengthwise along the length of the telescoping tubes 98 and 100. Such a covering would be notched out at appropriate locations for the protrusion of the mounting tabs 128 for the hoods 18. Rather than a cloth covering, a light-weight, tunnel-shaped plastic canopy could be utilized to hide the operating mechanism of the display mount 96 from view.

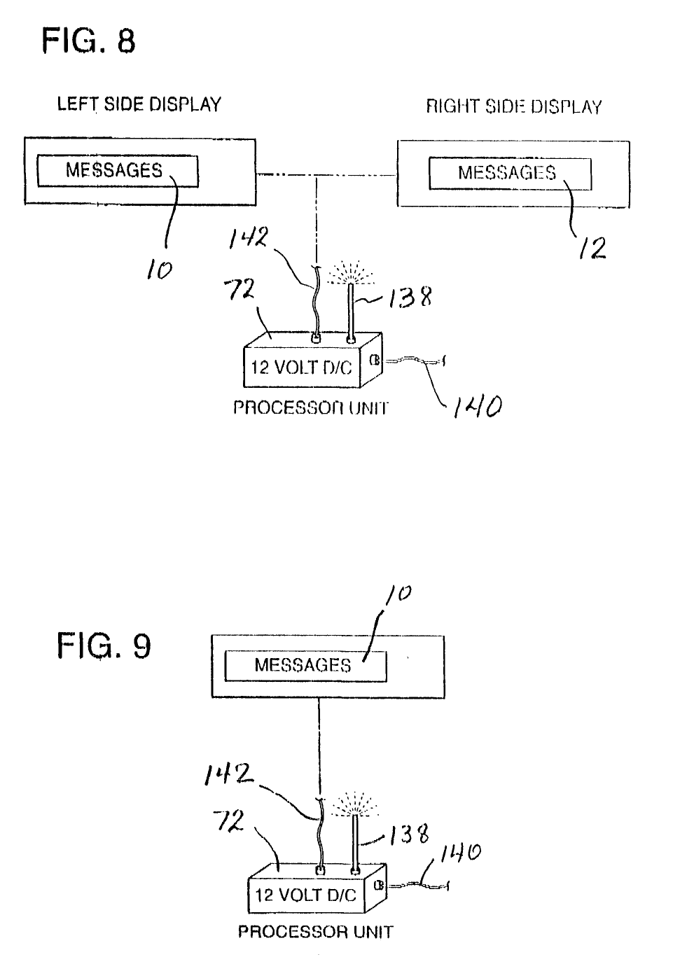

The protective case 72 contains the power supply for the electronically operated visual message display system of the invention, and also the display drivers and the electronic memory and processing circuits required for the operation of the courtesy message display system of the invention. The protective case 72 is preferably formed as a hardy, rigid metal or plastic case that contains most of the operating electronic components of the invention, as illustrated in FIG. 1. As previously indicated, the case 72 is preferably fastened to the underside of the rear deck panel 74. As illustrated in FIG. 8, the protective case 72 is equipped with a receiving antenna 138 that receives signals transmitted by the transmitter circuit 48. The antenna 138 is connected to the radio frequency receiver 54 that is encapsulated within the protective case 72.

The courtesy message display system of the invention is operated by direct electrical current that may be supplied by a power cord 140 that is either wired into the vehicle electrical DC power system, or connected to a plug that is inserted into the cigarette lighter socket found in most, if not all, commercially available automotive vehicles.

As illustrated in FIG. 8, an output signal cable 142 emanates from the protective case 72 and carries the display driver signals to the message display screens 10 and 12. The cable 142 also carries the audio signal from the audio amplifier 66 to the speaker 68 that is located in the display screen 10. The speaker 68 is positioned on the forwardly facing side of the display 10 right behind the speaker grill 88 of the hood 18 thereof.

To utilize the electronically operated visual courtesy display system illustrated, the driver of an automotive vehicle will normally drive with the unit on by depressing the “on” sensor 24 on the operator console pad 20. This activates the power supply within the casing 72 to couple the twelve-volt vehicle DC power supply from the power cable 140 and step down the voltage to the normal five-volt power supply required by most electronic processing circuitry.

When traffic conditions warrant, the driver will depress a selected one of the message touch sensors 28 through 42. That is, for example, if the driver of the automotive vehicle 16 is seeking to enter a lane of heavy traffic by merging from a right-hand position into the lane of traffic, which may be located to the left of the vehicle 16, the driver depresses the touch sensor 28. The signal identifying the sensor 28 is then encoded by the signal encoder 46 and transmitted by the transmitter 48 to the processor unit, which receives the signal with the radio frequency receiver 54. This signal is decoded by the decoder 56 and the microprocessor controller 52 retrieves the electronically encoded version of the message “Sorry, please let me in” from the text message storage unit 50.

The microprocessor controller 52 then outputs the electronic version of this message to the display control circuit 58. The character generator 60 supplies the display driver information necessary to operate the display screen 10 or the display screen 12 to display the appropriate alphanumeric characters thereon. Because the microprocessor controller 52 detected that the message selected was from the touch sensor 28, which it associates with the message display screen 10 to the exclusion of the message display screen 12, the display control circuit 58 directs the driver signals from the character generator 60 only to the display screen 10. The display message thus appears as illustrated in FIG. 2 in the display screen 10 that is located behind the rear passenger seat 92 on the driver's side of the vehicle.

Concurrently with the visual display, the microprocessor controller 52 actuates the voice playback circuit 62, which retrieves a stored audio version of the same message “Sorry, please let me in” and transmits it to the audio amplifier 66, which in turn directs the audio message to the speaker 68. For the sake of economy, a single speaker 68 located in the back of the display screen 10 serves both the visual message display screens 10 and 12. The speaker 68 provides an audible announcement of the message that may easily be heard by the driver, since the speaker 68 is directed forwardly and is located right behind the speaker grill 88 in the hood 18 in which the display screen 10 is located.

By providing an audio announcement, the visual attention of the driver is not unduly distracted to ensure that the correct message has been selected. Should the driver determine that the wrong message was selected, the driver can quickly abort the message by depressing the “off” sensor 26 on the operator console 20. This would be followed by depression of the “on” touch sensor 24, followed by depression of the touch sensor associated with the correct message to be displayed.

In a typical situation, once the courtesy message of the type illustrated in FIG. 2 has been visually displayed, it is readily observable by a driver of another vehicle located behind the vehicle 16. Since the hood 18 shades the display screens 10 and 12, the visual display on the message display screens 10 and 12 is not obscured by ambient light, even in bright sunshine. Accordingly, the message display system of the invention is not only useful during hours of darkness, like conventional courtesy message display systems, but is also useful during daylight hours.

Upon observing a message such as that displayed in FIG. 2, the driver of a following vehicle will normally allow the vehicle 16 to enter the lane of traffic as a matter of courtesy. In such a situation, once the vehicle following the vehicle 16 has obliged the driver of the vehicle 16, display of a “thank you” message is normally warranted. To provide such a visual message display, the driver of the vehicle 16 merely depresses the touch sensor 30, which is associated with the electronically stored message “Thank you for your kindness”. Pressure upon the touch sensor 30 thereupon generates an encoded signal from the signal encoder 46 which is transmitted by the transmitter 48 as a radio frequency signal. This signal is then detected by the receiver 54 and processed in the same manner previously described. The only difference in the processing is that, since the touch sensor 30 is associated with the display screen 12, the display control circuit 58 provides the alphanumeric output from the character generator 60 to the display screen 12, rather than the display screen 10. The displayed message thereupon appears as illustrated in FIG. 3. Again, an audio announcement of the message being displayed on the display screen 12 is announced to the driver of the vehicle 16 through the speaker 68 that is housed with the display screen 10.

A dual display screen system employing visual displays 10 and 12 is appropriate for use on many passenger motor vehicles. However, in some vehicles the interior passenger compartment configuration is such that the use of a single display screen 10 is more appropriate. Such an arrangement is illustrated in FIG. 9 and is appropriate for use on vehicles, such as sport utility vehicles, vans, and other vehicles which do not have a pair of laterally separated rear seat headrests located proximate to the rear windshield of a vehicle: In the case of a system employing a single message display screen 10, such as that illustrated in FIG. 9, all of the touch sensors 28 through 42 would elicit messages for display from the processor unit for display on the single message display screen 10.

The display screens 10 and 12 are always located within a vehicle. Consequently, they are not subject to vandalism or weather damage like message display systems that are located externally on a vehicle.

All the messages stored in the text message storage unit 50 are preprogrammed so that the touch-sensitive sensors 28 through 42 can only be utilized to select predetermined, courteous messages. The use of certain preprogrammed messages avoids the display of any message that might be considered to be inflammatory or reflective of “road rage”.

The form in which the message is displayed on the display screens 10 and 12 may vary. That is, if the message is short enough it will appear as a single, static image on the display screen 10 or 12. Alternatively, if the message is too long to be displayed in a single static display, the display control circuit 58 is capable of operating the display screens 10 and 12 to display messages in a running sequence of alphanumeric characters, typically moving from right to left from the standpoint of the viewer. Alternatively, the message can be flashed out in a sequential series of static displays. The message may also be displayed as a vertically rolling message.

The audibly spoken message emanating from the speaker 68 is announced at the same time that the message is visually displayed on the display screen 10 or 12. The driver can thereby abort the message if one of the touch sensors 28-42 has been touched in error. While it is possible for the audio message to precede the visual display, this typically would create an undesirable situation in which the visual display of the message would be delayed for too long a time.

Undoubtedly, numerous variations and modifications of the invention will become readily apparent to those familiar with automotive vehicle courtesy message display systems. For example, many different messages other than those specifically indicated in FIG. 7 may be selected for display. Also, different mounting and latching systems from those indicated in FIG. 5 may be employed to mount and orient the display screens relative to the rear vehicle windshield. Accordingly, the scope of the invention should not be construed as limited to the specific embodiment depicted and described, but rather is defined in the claims appended hereto.

I claim

1. An electronic courtesy message display system for mounting within the enclosure of an automotive vehicle comprising:
a display unit having an elongated display screen for positioning for viewing through the rear window of an automotive vehicle and a hood positioned to shade said display screen,
an operator console for mounting upon the steering wheel of an automotive vehicle, and including a plurality of touch-sensitive sensors, a unique operator message indicia for each of said sensors, and a transmitter for generating a unique sensor identifying signal for each of said sensors,
an electronic storage memory containing a plurality of preprogrammed alphanumeric messages in electronically encoded form and responsive to each sensor identifying signal to select a corresponding one of said preprogrammed messages,
a display driver unit coupled to receive messages from said electronic storage memory as they are selected and to actuate a corresponding character display by said display screen, and
a speaker that audibly announces each message contemporaneously with its selection by said touch-sensitive sensors.

2. An electronic courtesy message display system according to claim 1 wherein said display unit has opposing ends and said hood is equipped with side blinders at said opposing ends and an overhead visor projecting rearwardly above said display screen and toward said rear window of said automotive vehicle.

3. An electronic courtesy message display system according to claim 2 wherein said overhead visor is adjustable in orientation relative to said display screen.

4. An electronic courtesy message display system according to claim 1 further comprising a mounting device for supporting said display screen relative to said vehicle rear window including a pair of elongated, laterally extending support tubes having inboard telescoping ends and opposite outboard ends and said support tubes extend across the width of said vehicle proximate said rear window thereof, padded feet on both of said outboard ends of said tubes, and an extension mechanism for forcing and holding said outboard ends of said tubes apart from each other and against said vehicle.

5. An electronic courtesy message display system according to claim 4 wherein said extension mechanism includes a rack, a pinion and a latch device for holding said pinion at a selected location relative to said rack.

6. An electronic courtesy message display system according to claim 1 further comprising a pair of said elongated display screens as aforesaid.

7. An electronic courtesy message display system according to claim 6 wherein said plurality of sensors are located in an array of two columns, one associated with each of said display screens.

8. An electronic courtesy message display system according to claim 1 further comprising a protective casing containing said electronic storage memory and said display driver unit and located apart from said display screen, said operator console and said speaker for concealment from view within said vehicle.

9. An electronic courtesy message display system comprising:
an elongated display unit for positioning in the rear windshield of automotive vehicle and having a display screen for displaying a linear array of alphanumeric characters,
a sunshield that casts a shadow on said display screen,
an audio speaker,
a message selection device containing a plurality of preselected electronically encoded messages, each formed of a different set of selected alphanumeric characters in a selected sequence, and a receiver for responding to remotely generated signals to display a set of selected alphanumeric characters in a selected sequence,
a touch-sensitive operator panel for positioning on the steering wheel of an automotive vehicle and containing touch-sensitive selectors for alternatively selecting one of said plurality of encoded messages for display, and a transmitter for generating a signal recognized by said receiver as specifying said selected one of said messages, and
a display driver unit separate from said elongated display unit and coupled thereto to respond to said receiver by actuating said display screen to display said selected message on said display screen and by actuating said audio speaker to audibly announce said selected message.

10. An electronic courtesy message display system according to claim 9 wherein said sunshield is formed as a hood having opposing side blinders and an overhead visor extending rearwardly from said display screen and between said side blinders.

11. An electronic courtesy message display system according to claim 10 wherein said overhead visor includes a laterally extending living hinge so that the orientation of at least a portion of said overhead visor relative to said display screen is adjustable.

12. An electronic courtesy message display system according to claim 9 further comprising a pair of display screens as aforesaid, one for positioning behind a rear seat headrest on the driver's side of said vehicle and the other for positioning behind a rear seat headrest on the passenger's side of said vehicle.

13. An electronic courtesy message display system according to claim 12 further comprising a laterally extending display screen mount including a pair of telescoping tubes, each having an inboard end and an outboard end, padded feet located at said outboard ends of said tubes, and a rack and pinion crank mechanism located at said inboard ends of said tubes for selectively adjusting and maintaining a desired degree of telescopic offset between said tubes.

14. An electronic courtesy message display system according to claim 13 wherein said padded feet are joined to said outboard ends of said telescoping tubes by omnidirectional connectors.

15. An electronic courtesy message display system according to claim 14 wherein said omnidirectional connectors are ball and socket connectors.

16. An electronic courtesy message display system according to claim 13 wherein said telescoping tubes are each of uniform outer cross section throughout and further comprising a pair of mounting brackets slidably mounted on said telescoping tubes and including releaseable clamps for locking said mounting brackets at selected locations along said telescoping tubes.

17. An electronic courtesy message display system according to claim 9 wherein said steering wheel has a center, a rim, and radial spokes joining said center to said rim, and said touch-sensitive operator panel is formed as a flat pad and has a releaseable band for passing between said spokes of said steering wheel to secure said touch-sensitive operator panel to said steering wheel supported from behind by said center of said steering wheel.

18. An electronic courtesy message display system according to claim 9 further comprising a protective case containing said message selection device and said display driver unit and said protective case is located separately from said display screen and from said operator panel.

19. An electronically operated visual message display system for an automotive vehicle comprising:
a message display screen positionable for viewing through the rear window of an automotive vehicle from the exterior thereof,
a display screen hood for shading said display screen,
an operator console for mounting on the center of a steering wheel of an automotive vehicle and including an array of a plurality of individually actuable, touch-sensitive selectors, each of which, upon actuation, provides a unique identifying electronic signal, and indicia on each of said touch sensitive selectors for visually identifying to an operator a unique alphanumeric message associated with each of said selectors,
an electronic storage memory in remote communication with said operator console and containing a plurality of displayable visual alphanumeric messages in electronically encoded form and responsive to each of said unique identifying electronic signals to recall a corresponding one of said alphanumeric messages from memory and provide it in electronically encoded form,
a controller for detecting and decoding said alphanumeric messages as they are generated,
a display driver unit connected to said controller and responsive thereto to provide actuating signals to said display screen to visually display said alphanumeric messages as they are designated by corresponding ones of said selectors, and
a speaker responsive to said selectors to audibly and contemporaneously announce each message as it is recalled by said electronic storage memory.

20. An electronically operated visual message display system according to claim 19 wherein said display screen hood has side blind panels and a rearwardly projecting overhead visor located atop and between said side blind panels and said overhead visor includes a laterally extending hinge and is thereby adjustable in orientation relative to said side blind panels.
